(19) United States
(12) Patent Application Publication
(10) Pub. No.: US 2026/0353235 A1
(43) Pub. Date: Nov. 5, 2026

(54) METHODS AND APPARATUSES OF A POSITIONING MECHANISM FOR A UE

(71) Applicant: LENOVO (BEIJING) LIMITED, Beijing (CN)

(72) Inventors: Lianhai WU, Beijing (CN); Jie HU, Beijing (CN); Ran YUE, Beijing (CN); Haiming WANG, Beijing (CN); Jing HAN, Beijing (CN); Min XU, Beijing (CN)

(21) Appl. No.: 19/101,729

(22) PCT Filed: Aug. 9, 2022
(86) PCT No.: PCT/CN2022/111228

§ 371 Date: Feb. 6, 2025

(51) Int. Cl. H04W 36/32; H04W 36/00; H04W 76/19; H04W 92/18

(52) U.S. Cl. CPC H04W 36/322; H04W 36/0058; H04W 76/19; H04W 92/18

(57) ABSTRACT

Embodiments of the present application relate to methods and apparatuses of a positioning mechanism for a user equipment (UE), e.g., in a relay scenario, a mobility scenario, and/or an RRC re-establishment scenario. According to an embodiment of the present application, a user equipment (UE) includes a processor and a transceiver coupled to the processor; and the processor is configured to: receive configuration information associated with a downlink-positioning reference signal (DL-PRS) via the transceiver from a network node; start to perform a positioning measurement operation based on the configuration information; after starting to perform the positioning measurement operation, initiate a radio resource control (RRC) reestablishment procedure or a handover procedure from the network node to a target network node; and determine whether to continue performing the positioning measurement operation in response to initiating the RRC reestablishment procedure or the handover procedure.

### TECHNICAL FIELD

Embodiments of the present application generally relate to wireless communication technology, in particular to methods and apparatuses of a positioning mechanism for a user equipment (UE).

### BACKGROUND

A base station (BS) can have some cells (or areas) to provide communication service. When a UE moves from a serving cell of a source BS to a target cell of a target BS, a handover procedure is performed. When a radio link failure (RLF) or a handover (HO) failure occurs for a UE, the UE may perform a radio resource control (RRC) reestablishment procedure. The UE may access a cell by a successful RRC reestablishment procedure. The accessed network will request UE information including a RLF report of the UE, such that the network can optimize the mobility problem based on the UE information from the UE. Accordingly, the UE will transmit a failure report to the network.

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a BS or a core network.

In the 3rd Generation Partnership Project (3GPP), deployment of a relay node (RN) in a wireless communication system is promoted. One objective of deploying a RN is to enhance the coverage area of a BS by improving the throughput of a UE that is located in the coverage or far from the BS, which can result in relatively low signal quality. A RN may also be named as a relay UE in some cases. A 3GPP 5G sidelink system including a relay UE may be named as a sidelink relay system. In a layer-2 (L2) UE-to-Network (U2N) relay scenario, a U2N relay UE is a UE that provides functionality to support connectivity to the network for U2N remote UE(s).

3GPP 5G networks are expected to increase network throughput, coverage, and robustness and reduce latency and power consumption. With the development of 3GPP 5G networks, various aspects need to be studied and developed to perfect the 5G technology. Currently, details regarding a positioning mechanism for a UE, e.g., in a relay scenario, a mobility scenario, and/or an RRC re-establishment scenario, has not been discussed in 3GPP 5G technology yet.

### SUMMARY

Some embodiments of the present application provide a user equipment (UE). The UE includes a processor and a transceiver coupled to the processor; and the processor is configured to: receive configuration information associated with a downlink-positioning reference signal (DL-PRS) via the transceiver from a network node; start to perform a positioning measurement operation based on the configuration information; after starting to perform the positioning measurement operation, initiate a radio resource control (RRC) reestablishment procedure or a handover procedure from the network node to a target network node; and determine whether to continue performing the positioning measurement operation in response to initiating the RRC reestablishment procedure or the handover procedure.

In some embodiments, performing the positioning measurement operation including receiving the DL-PRS.

In some embodiments, the processor of the UE is configured to receive first configuration information associated with a first set of measurement gaps or a first set of PRS processing windows (PPW)s via the transceiver from the network node.

In some embodiments, in response to initiating the RRC reestablishment procedure, the processor of the UE is configured to continue to perform the positioning measurement operation during the RRC reestablishment procedure.

In some embodiments, the processor of the UE is configured to perform one of: maintaining the first configuration information; and releasing the first configuration information, and continuing to receive the DL-PRS during the RRC reestablishment procedure.

In some embodiments, in response to releasing the first configuration information, the processor of the UE is configured to monitor a physical downlink control channel (PDCCH) transmission in response to at least one of: a timer for a random access (RA) response window is running; an RA contention resolution timer is running; or a timer for an MsgB response window is running.

In some embodiments, in response to initiating the RRC reestablishment procedure, the processor of the UE is configured to stop performing the positioning measurement operation.

In some embodiments, the processor of the UE is configured to stop receiving the DL-PRS upon initiating the RRC reestablishment procedure.

In some embodiments, the processor of the UE is configured to: receive an RRC reestablishment message from a reestablished cell; and restart to perform the positioning measurement operation in response to receiving the RRC reestablishment message.

In some embodiments, in response to initiating the handover procedure, the processor of the UE is configured to continue to perform the positioning measurement operation during the handover procedure.

In some embodiments, the processor of the UE is configured to monitor a physical downlink control channel (PDCCH) transmission during the handover procedure in response to at least one of: a timer for a random access (RA) response window is running; an RA contention resolution timer is running; or a timer for an MsgB response window is running.

In some embodiments, the processor of the UE is configured to receive a first indication for activating or deactivating a first measurement gap within the first set of measurement gaps or a first PPW within the first set of PPWs via the transceiver from the network node.

In some embodiments, the processor of the UE is configured to receive, via the transceiver from the target network node, at least one of: second configuration information associated with a second set of measurement gaps or a second set of PPWs; or a second indication for activating or deactivating a second measurement gap within the second set of measurement gaps or a second PPW within the second set of PPWs.

In some embodiments, the second configuration information includes the second indication.

In some embodiments, the first indication includes at least one of: an identifier (ID) of the first measurement gap or the first PPW; an indicator for indicating activation of the first measurement gap or the first PPW; or an indicator for indicating deactivation of the first measurement gap or the first PPW; and wherein the second indication includes at least one of: an ID of the second measurement gap or the second PPW; an indicator for indicating activation of the second measurement gap or the second PPW; or an indicator for indicating deactivation of the second measurement gap or the second PPW.

In some embodiments, the positioning measurement operation is performed based on one of: the first configuration information and the first indication; the first configuration information and the first indication in response to a handover timer being running; the at least one of the second configuration information and the second indication; and prohibiting considering the first configuration information, the first indication, the second configuration information, and the second indication.

In some embodiments, in response to prohibiting considering the first configuration information, the first indication, the second configuration information, and the second indication, the processor of the UE is configured to continue to receive the DL-PRS during the handover procedure.

In some embodiments, in response to initiating the handover procedure, the processor of the UE is configured to stop performing the positioning measurement operation.

In some embodiments, the processor of the UE is configured to stop receiving the DL-PRS upon initiating the handover procedure.

In some embodiments, the processor of the UE is configured to restart to perform the positioning measurement operation in response to at least one of: transmitting an RRC reconfiguration complete message; stopping a handover timer; or receiving an RRC reconfiguration message from the target network node.

Some embodiments of the present application provide a user equipment (UE). The UE includes a processor and a transceiver coupled to the processor; and the processor is configured to: access a network node over an indirect path associated with a relay node; receive first configuration information associated with a set of measurement gaps or a set of positioning reference signal processing windows (PPW)s via the transceiver from the relay node, wherein the UE is allowed to receive a downlink-positioning reference signal (DL-PRS) in an activated measurement gap or an activated PPW; and receive an indication for activating or deactivating a measurement gap within the set of measurement gaps or a PPW within the set of PPWs via the transceiver from the relay node.

In some embodiments, the processor of the UE is configured to receive second configuration information associated with the DL-PRS.

In some embodiments, the indication received from the relay node is included in at least one of: a PC5 sidelink relay adaptation protocol (SRAP) control protocol data unit (PDU); or a PC5 medium access control (MAC) control element (CE).

In some embodiments, the indication includes at least one of: an identifier (ID) of the measurement gap or the PPW; an indicator for indicating activation of the measurement gap or the PPW; an indicator for indicating deactivation of the measurement gap or the PPW; or information regarding one or more frequency resources for the UE receiving the indication.

In some embodiments, in response to the indication including the indicator for indicating the activation of the PPW, the processor of the UE is configured to prohibit receiving a transmission on a PC5 path within the PPW.

In some embodiments, the transmission on the PC5 path includes at least one of: a physical sidelink control channel (PSCCH) transmission; a physical sidelink shared channel (PSSCH) transmission; or a sidelink share channel (SL-SCH) transmission.

In some embodiments, the UE may transmit a first request for activation or deactivation of the measurement gap via the transceiver to the relay node.

In some embodiments, the first request is included in at least one of: a PC5SRAP control PDU; or a PC5 MAC CE.

In some embodiments, the first request includes at least one of: an ID of the measurement gap; an indicator for indicating activation of the measurement gap; or an indicator for indicating deactivation of the measurement gap.

Some embodiments of the present application provide a relay UE. The relay UE includes a processor and a transceiver coupled to the processor; and the processor is configured to: receive configuration information associated with a set of measurement gaps or a set of positioning reference signal processing windows (PPW)s via the transceiver from a network node; transmit the configuration information via the transceiver to a user equipment (UE), wherein the UE is allowed to receive a downlink-positioning reference signal (DL-PRS) in an activated measurement gap or an activated PPW; receive a first indication for activating or deactivating a measurement gap within the set of measurement gaps or a PPW within the set of PPWs via the transceiver from the network node; and transmit a second indication for activating or deactivating the measurement gap or the PPW via the transceiver to the UE.

In some embodiments, the first indication includes at least one of: an identifier (ID) of the measurement gap or the PPW; an indicator for indicating activation of the measurement gap or the PPW; an indicator for indicating deactivation of the measurement gap or the PPW; information regarding one or more frequency resources for the UE receiving the second indication; or an ID of the UE.

In some embodiments, the first indication received from the network node is included in at least one of: a Uu sidelink relay adaptation protocol (SRAP) control protocol data unit (PDU); or a Uu medium access control (MAC) control element (CE).

In some embodiments, the second indication includes at least one of: an identifier (ID) of the measurement gap or the PPW; an indicator for indicating activation of the measurement gap or the PPW; an indicator for indicating deactivation of the measurement gap or the PPW; or information regarding one or more frequency resources for the UE receiving the second indication.

In some embodiments, the second indication transmitted to the UE is included in at least one of: a PC5 SRAP control PDU; or a PC5 MAC CE.

In some embodiments, the processor of the relay node is configured to receive a first request for activation or deactivation of the measurement gap via the transceiver from the UE.

In some embodiments, the first request is included in at least one of: a PC5 SRAP control PDU; or a PC5 MAC CE.

In some embodiments, the first request includes at least one of: an ID of the measurement gap; an indicator for indicating activation of the measurement gap; or an indicator for indicating deactivation of the measurement gap.

In some embodiments, the processor of the relay node is configured to transmit a second request for the activation or deactivation of the measurement gap via the transceiver to the network node.

In some embodiments, the second request is included in at least one of: a Uu SRAP control PDU; or a Uu MAC CE.

In some embodiments, the second request includes at least one of: an ID of the measurement gap; an indicator for indicating activation of the measurement gap; or an indicator for indicating deactivation of the measurement gap; or an ID of the UE.

Some embodiments of the present application provide a network node (e.g., a BS). The network node includes a processor and a transceiver coupled to the processor; and the processor is configured to: transmit configuration information associated with a set of measurement gaps or a set of positioning reference signal processing windows (PPW)s for a user equipment (UE) via the transceiver to a relay node, wherein the UE is configured to access the network node over an indirect path associated with the relay node, and wherein the UE is allowed to receive a downlink-positioning reference signal (DL-PRS) in an activated measurement gap or an activated PPW; and transmit an indication for activating or deactivating a measurement gap within the set of measurement gaps or a PPW within the set of PPWs via the transceiver to the relay node.

In some embodiments, the indication includes at least one of: an identifier (ID) of the measurement gap or the PPW; an indicator for indicating activation of the measurement gap or the PPW; an indicator for indicating deactivation of the measurement gap or the PPW; information regarding one or more frequency resources for the UE receiving an indication for activation or deactivation of the measurement gap or the PPW; or an ID of the UE.

In some embodiments, the indication is included in at least one of: a Uu sidelink relay adaptation protocol (SRAP) control protocol data unit (PDU); or a Uu medium access control (MAC) control element (CE).

In some embodiments, the processor of the network node is configured to receive a request for activation or deactivation of the measurement gap via the transceiver from the relay node.

In some embodiments, the request is included in at least one of: a Uu SRAP control PDU; or a Uu MAC CE.

In some embodiments, the request includes at least one of: an ID of the measurement gap; an indicator for indicating activation of the measurement gap; or an indicator for indicating deactivation of the measurement gap; or an ID of the UE.

Some embodiments of the present application provide a method, which may be performed by a UE. The method includes: receiving configuration information associated with a downlink-positioning reference signal (DL-PRS) from a network node; starting to perform a positioning measurement operation based on the configuration information; after starting to perform the positioning measurement operation, initiating a radio resource control (RRC) reestablishment procedure or a handover procedure from the network node to a target network node; and determining whether to continue performing the positioning measurement operation in response to initiating the RRC reestablishment procedure or the handover procedure.

Some embodiments of the present application provide a method, which may be performed by a UE. The method includes: accessing a network node over an indirect path associated with a relay node; receiving configuration information associated with a set of measurement gaps or a set of positioning reference signal processing windows (PPW)s from the relay node, wherein the UE is allowed to receive a downlink-positioning reference signal (DL-PRS) in an activated measurement gap or an activated PPW; and receiving an indication for activating or deactivating a measurement gap within the set of measurement gaps or a PPW within the set of PPWs from the relay node

Some embodiments of the present application provide a method, which may be performed by a relay node. The method includes: receiving configuration information associated with a set of measurement gaps or a set of positioning reference signal processing windows (PPW)s from a network node; transmitting the configuration information to a user equipment (UE), wherein the UE is allowed to receive a downlink-positioning reference signal (DL-PRS) in an activated measurement gap or an activated PPW; receiving a first indication for activating or deactivating a measurement gap within the set of measurement gaps or a PPW within the set of PPWs from the network node; and transmitting a second indication for activating or deactivating the measurement gap or the PPW to the UE.

Some embodiments of the present application provide a method, which may be performed by a network node (e.g., a BS). The method includes: transmitting configuration information associated with a set of measurement gaps or a set of positioning reference signal processing windows (PPW)s for a user equipment (UE) to a relay node, wherein the UE is configured to access the network node over an indirect path associated with the relay node, and wherein the UE is allowed to receive a downlink-positioning reference signal (DL-PRS) in an activated measurement gap or an activated PPW; and transmitting an indication for activating or deactivating a measurement gap within the set of measurement gaps or a PPW within the set of PPWs to the relay node.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE, a relay UE, or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure.

FIG. 2 illustrates another schematic diagram of a wireless communication system in accordance with some embodiments of the present disclosure.

FIG. 3 illustrates an exemplary control plane protocol stack for a relay scenario in accordance with some embodiments of the present disclosure.

FIG. 4 illustrates an exemplary format of a positioning measurement gap activation or deactivation request MAC CE in accordance with some embodiments of the present disclosure.

FIG. 5 illustrates a flowchart of an exemplary procedure of a positioning measurement operation in accordance with some embodiments of the present disclosure.

FIGS. 6 and 7 illustrate flowcharts of exemplary procedures of wireless communications in accordance with some embodiments of the present disclosure.

FIGS. 8-10 illustrate flowcharts of exemplary procedures of a positioning measurement operation in accordance with some embodiments of the present disclosure.

FIGS. 11 and 12 illustrate flowcharts of exemplary procedures of wireless communications in accordance with some embodiments of the present disclosure.

FIG. 13 illustrates a block diagram of an exemplary apparatus in accordance with some embodiments of the present disclosure.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

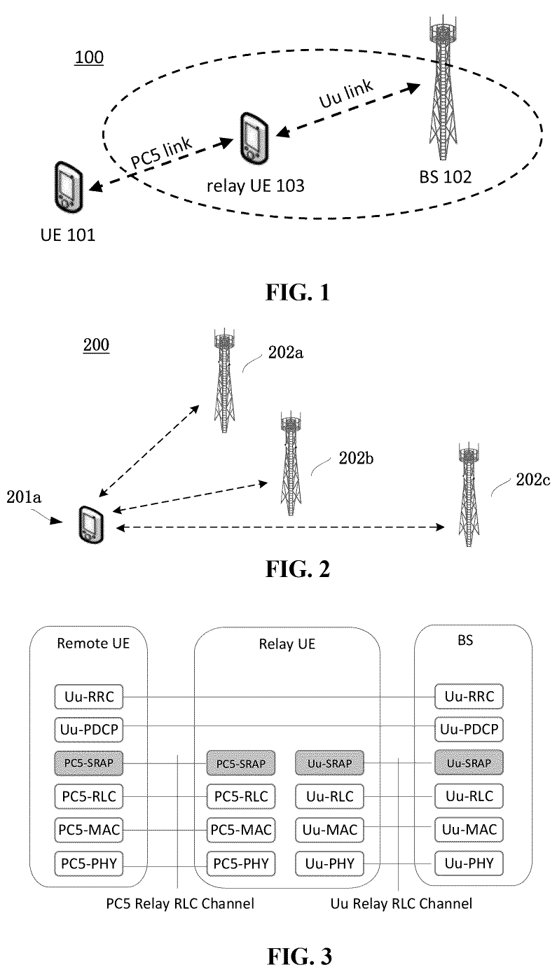

FIG. 1 illustrates a schematic diagram of a wireless communication system 100 in accordance with some embodiments of the present disclosure. The wireless communication system 100 includes UE 101, BS 102, and relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101 and BS 102, these they communicate with each other via relay UE 103. UE 101 may be connected to relay UE 103 via a network interface, for example, a PC5 interface as specified in 3GPP standard documents. Relay UE 103 may be connected to BS 102 via a network interface, for example, a Uu interface as specified in 3GPP standard documents. Referring to FIG. 1, UE 101 is connected to relay UE 103 via a PC5 link, and relay UE 103 is connected to BS 102 via a Uu link. UE 101 may be a U2N remote UE. Relay UE 103 may be a U2N relay UE, which is a UE that provides functionality to support connectivity to the network for U2N remote UE(s).

In some embodiments of the present application, UE 101 or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101 or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 or relay UE 103 may include wearable devices, such as smart watches, fitness bands, optical head-mounted displays, or the like. Moreover, UE 101 or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101 or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 702.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

BS(s) 102 may include one or more cells. UE(s) 101 may perform a cell section procedure between different cell(s) of different BS(s). UE(s) 101 may handover from a serving cell of a source BS to a target cell of a target BS. For example, in the wireless communication system 100 as illustrated and shown in FIG. 1, BS 102 as illustrated and shown in FIG. 1 may function as a source BS, and a further BS 102 (not shown in FIG. 1) may function as a target BS. If there is a handover need, UE 101 as illustrated and shown in FIG. 1 may perform a handover procedure from a serving cell of BS 102 to a target cell of the further BS, which depends on the measurement result. For instance, the handover procedure performed by UE 101 may be a conditional handover (CHO) procedure. A specific example is described in the embodiments of FIG. 2.

FIG. 2 illustrates another schematic diagram of a wireless communication system 200 in accordance with some embodiments of the present disclosure. The wireless communication system 200 is a specific example of the wireless communication system 100 in FIG. 1, UE 201a is a specific example of UE 101 in FIG. 1, and each of BS 202a, BS 202b, and BS 202c is a specific example of BS 102 in FIG. 1. Different from the wireless communication system 100, there is no relay node between UE 201a and BS(s) 202 in the wireless communication system 200, and UE 201a and BS(s) 202 may directly communicate with each other.

Each BS(s) 202 may include one or more cells. UE 201a may perform a cell section procedure between different cell(s) of different BS(s). UE 201a may handover from a serving cell of a source BS to a target cell of a target BS. For example, in the wireless communication system 200, BS 202a may function as a source BS, and each of BS 202b and BS 202c may function as a target BS. If there is a handover need, UE 201a as illustrated and shown in FIG. 2 may perform a handover procedure from a serving cell of BS 202a to a target cell of BS 202b or a target cell of BS 202c, which depends a result of a cell selection procedure. For instance, the handover procedure performed by UE 201a may be a CHO procedure.

As specified in 3GPP standard documents, CHO is defined as a handover that is executed by a UE when one or more handover execution conditions are met. The UE starts evaluating the execution condition(s) upon receiving the CHO configuration, and stops evaluating the execution condition(s) during the CHO procedure once the execution condition(s) is met.

FIG. 3 illustrates an exemplary control plane protocol stack for a relay scenario in accordance with some embodiments of the present disclosure.

As shown in FIG. 3, for a relay, for uplink (UL):
The Uu SRAP sublayer performs UL bearer mapping between ingress PC5 Relay RLC channels for relaying and egress Uu Relay RLC channels over the Relay UE Uu interface. For uplink relaying traffic, the different end-to-end Uu Radio Bearers (SRBs or DRBs) of the same Remote UE and/or different Remote UEs can be multiplexed over the same egress Uu Relay RLC channel.
The Uu SRAP sublayer supports Remote UE identification for the UL traffic. The identity information of Remote UE end-to-end Uu Radio Bearer and a local Remote UE ID are included in the Uu SRAP header at UL in order for a BS to correlate the received packets for the specific PDCP entity associated with the right end-to-end Uu Radio Bearer of the Remote UE.
The PC5 SRAP sublayer at the Remote UE supports UL bearer mapping between Remote UE end-to-end Uu Radio Bearers and egress PC5 Relay RLC channels.

As shown in FIG. 3, for a relay, for downlink (DL):
The Uu SRAP sublayer performs DL bearer mapping at the BS to map end-to-end Uu Radio Bearer (SRB, DRB) of Remote UE into Uu Relay RLC channel over Relay UE Uu interface. The Uu SRAP sublayer performs DL bearer mapping and data multiplexing between multiple end-to-end Radio Bearers (SRBs or DRBs) of a Remote UE and/or different Remote UEs and one Uu Relay RLC channel over the Relay UE Uu interface.
The Uu SRAP sublayer supports Remote UE identification for DL traffic. The identity information of Remote UE end-to-end Uu Radio Bearer and a local Remote UE ID are included into the Uu SRAP header by the BS at DL for end-to-end Relay UE to map the received packets from Remote UE end-to-end Uu Radio Bearer to its associated PC5 Relay RLC channel.
The PC5 SRAP sublayer at the Relay UE performs DL bearer mapping between ingress Uu Relay RLC channels and egress PC5 Relay RLC channels;
The PC5 SRAP sublayer at the Remote UE correlates the received packets for the specific PDCP entity associated with the right end-to-end Radio Bearer of the Remote UE based on the identity information included in the PC5 SRAP header.

In some embodiments of the present disclosure, a SRAP control PDU refers to control signalling in SRAP layer which may be exchanged between a UE and a relay node or between a relay node and a BS.

As specified in 3GPP standard documents, regarding positioning operations, to support positioning of a (target) UE and delivery of location assistance data to the UE with NG-RAN access in 5G System (5GS), location related functions are distributed in an architecture including a UE, a NG-RAN Node, an access and mobility management function (AMF), a location management function (LMF), and 5GC LCS Entities. For example, for a location service, there may be following operations.

Some entity in the 5GC (e.g., GMLC) may request some location service (e.g., positioning) for a target UE to the serving AMF; or the serving AMF for the target UE may determine the need for some location service (e.g., to locate the UE for an emergency call); or, the UE may request some location service (e.g., positioning or delivery of assistance data) to the serving AMF at the non-access stratum (NAS) level. Then, the AMF may transfer the location service request to an LMF. The LMF may instigate location procedures with the serving and possibly neighbouring ng-eNB or gNB in the NG-RAN—e.g., to obtain positioning measurements or assistance data. In addition, the LMF instigates location procedures with the UE—e.g., to obtain a location estimate or positioning measurements or to transfer location assistance data to the UE. The LMF may provide a location service response to the AMF and includes any needed results—e.g., a success or failure indication and, if requested and obtained, a location estimate for the UE. After that, the AMF returns a location service response to the 5GC entity (e.g., gateway mobile location centre (GMLC)) and includes any needed results—e.g., a location estimate for the UE, or the AMF uses the location service response received to assist the service that triggered this (e.g., may provide a location estimate associated with an emergency call to a GMLC), or, the AMF returns a location service response to the UE and includes any needed results—e.g., a location estimate for the UE.

Regarding a pre-configured measurement gap, to reduce latency of procedures for DL-PRS processing with measurement gaps, a set of measurement gap patterns can be pre-configured to a UE and activated or deactivated by a BS using DL MAC CE signaling to control DL-PRS measurement by the UE. The UE can request activation and deactivation of the pre-configured measurement gap using UL MAC CE signaling.

Regarding a pre-configured PRS processing window (PPW), to further reduce latency of DL-PRS processing, UEs can perform DL-PRS measurement outside measurement gaps and inside the active DL bandwidth part (BWP) with PRS having the same numerology as the active DL BWP. A BS can use RRC signalling to pre-configure a PPW and DL MAC CE signaling for activation of PPW, respectively. However, if the target UE is a remote UE accessing the BS via a relay UE, the BWP could be PC5 BWP. How to activate or deactivate a PPW for a remote UE in the relay scenario should be addressed.

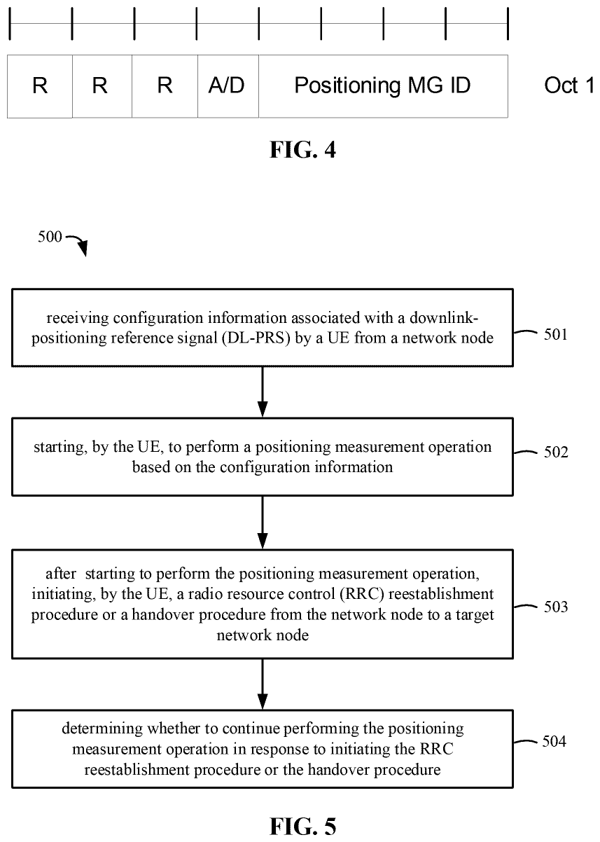

Generally, a BS may pre-configure a positioning measurement gap (may also be named as “a measurement gap for positioning” or “a measurement gap” or the like) for a UE to receive a DL-PRS. Then, the BS may transmit MAC CE (e.g., Positioning Measurement Gap Activation/Deactivation Command MAC CE) to control DL-PRS measurement by the UE. In addition, the UE may request activation and deactivation of the pre-configured positioning measurement gap using UL MAC CE (e.g., Positioning Measurement Gap Activation/Deactivation Request MAC CE as shown in FIG. 4). However, if the UE is a remote UE accessing the BS via a relay UE, MAC CE cannot be transmitted between the UE and the BS directly. Thus, an issue of how to activate or deactivate a positioning measurement gap for the remote UE in the relay scenario should be addressed.

FIG. 4 illustrates an exemplary format of a positioning measurement gap activation or deactivation request MAC CE in accordance with some embodiments of the present disclosure. As shown in FIG. 4, the positioning measurement gap activation or deactivation request MAC CE has a fixed 8-bit size:
Positioning MG ID: This field indicates the identifier for the pre-configured positioning measurement gap. The length of the field is 4 bits.
A/D: This field indicates the activation or deactivation of the positioning measurement gap. The field is set to 1 to indicate activation. The field is set to 0 to indicate deactivation. The length of the field is 1 bit.
R: reserved. The length of the field is 1 bit. There are three “R” fields in total in this MAC CE as shown in FIG. 4.

Currently, there is no positioning mechanism for a UE, e.g., in a relay scenario, a mobility scenario, and/or an RRC re-establishment scenario. For example, as described above, an issue of how to activate or deactivate a positioning measurement gap for a remote UE in the relay scenario needs to be addressed, and an issue of how to activate or deactivate a PPW for a remote UE in the relay scenario needs to be addressed. Embodiments of the present application aim to solve the abovementioned issues.

For instance, some embodiments of the present application study a mechanism in which a remote UE requests to activate or deactivate a positioning measurement gap in the relay scenario via lower layer. Some embodiments of the present application study a mechanism in which a BS activates or deactivates a positioning measurement gap for a remote UE in the relay scenario via lower layer. Some embodiments of the present application study a mechanism of activate or deactivate a pre-configured PPW for a remote UE in the relay scenario. Some embodiments of the present application study whether or how to continue to perform measurement for positioning during re-establishment. Some embodiments of the present application study whether or how to continue to perform measurement for positioning during handover. More details will be illustrated in the following text in combination with the appended drawings.

FIG. 5 illustrates a flowchart of an exemplary procedure 500 of a positioning measurement operation in accordance with some embodiments of the present disclosure. The exemplary procedure 500 may be performed by a UE, e.g., UE 101 or UE 201a as shown in FIG. 1 or FIG. 2. Although described with respect to a UE, it should be understood that other devices may be configured to perform a method similar to that of FIG. 5. Details described in all other embodiments of the present disclosure are applicable for the embodiments shown in FIG. 5.

In the exemplary procedure 500 as shown in FIG. 5, in operation 501, a UE may receive configuration information associated with a DL-PRS from a network node (e.g., BS 102 or BS 202a as shown in FIG. 1 or FIG. 2). For instance, the configuration information associated with the DL-PRS may be time-frequency resource configuration information for the DL-PRS.

In operation 502, the UE may start to perform a positioning measurement operation based on the configuration information. In some embodiments, performing the positioning measurement operation including receiving the DL-PRS.

In operation 503, after starting to perform the positioning measurement operation, the UE may initiate an RRC reestablishment procedure or a handover procedure from the network node (e.g., BS 202a as shown in FIG. 2) to a target network node (e.g., BS 202b or BS 202c as shown in FIG. 2).

In operation 504, the UE may determine whether to continue performing the positioning measurement operation in response to initiating the RRC reestablishment procedure or the handover procedure.

In some embodiments, the UE may receive configuration information (denoted as configuration information #1 for simplicity) associated with a set of measurement gaps (denoted as measurement gap set #1 for simplicity) or a set of PPWs (denoted as PPW set #1 for simplicity) from the network node.

In some embodiments, in response to initiating the RRC reestablishment procedure, the UE may continue to perform the positioning measurement operation during the RRC reestablishment procedure. In an embodiment, the UE may maintain configuration information #1. In another embodiment, the UE may release configuration information #1, and continue to receive the DL-PRS during the RRC reestablishment procedure. In response to releasing configuration information #1, the UE may monitor a PDCCH transmission in response to at least one of:
(1) a timer for a random access (RA) response window (e.g., ra-ResponseWindow) is running;
(2) an RA contention resolution timer (e.g., ra-ContentionResolutionTimer) is running; or
(3) a timer for an MsgB response window (e.g., msgB-ResponseWindow) is running.

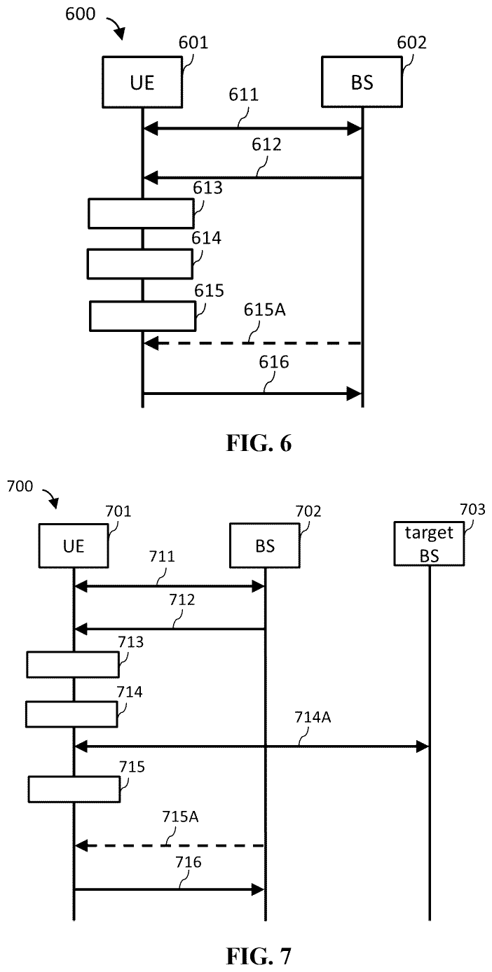

In some other embodiments, in response to initiating the RRC reestablishment procedure, the UE may stop performing the positioning measurement operation. In an embodiment, the UE may stop receiving the DL-PRS upon initiating the RRC reestablishment procedure. In some embodiment, the UE may receive an RRC reestablishment message from a reestablished cell, and restart to perform the positioning measurement operation in response to receiving the RRC reestablishment message. A specific example is described in the embodiments of FIG. 6 as follows.

In some embodiments, in response to initiating the handover procedure, the UE may continue to perform the positioning measurement operation during the handover procedure. In an embodiment, the UE may monitor a PDCCH transmission during the handover procedure in response to at least one of:
(1) a timer for an RA response window (e.g., ra-ResponseWindow) is running;
(2) an RA contention resolution timer (e.g., ra-ContentionResolutionTimer) is running; or
(3) a timer for an MsgB response window (e.g., msgB-ResponseWindow) is running. In some embodiments, the UE may receive an indication (denoted as indication #1) for activating or deactivating a measurement gap within measurement gap set #1 or a PPW within PPW set #1 from the network node. In an embodiment, indication #1 includes at least one of:
(1) an ID of the measurement gap or the PPW;
(2) an indicator for indicating activation of the measurement gap or the PPW; or
(3) an indicator for indicating deactivation of the measurement gap or the PPW.

In some embodiments, the UE may receive, from the target network node, at least one of:
(1) configuration information (denoted as configuration information #2) associated with another set of measurement gaps (denoted as measurement gap set #2) or another set of PPWs (denoted as PPW set #2); or
(2) an indication (denoted as indication #2) for activating or deactivating a measurement gap within measurement gap set #2 or a PPW within PPW set #2. In an embodiment, indication #2 includes at least one of:
   (a) an ID of the measurement gap or the PPW;
   (b) an indicator for indicating activation of the measurement gap or the PPW; or
   (c) an indicator for indicating deactivation of the measurement gap or the PPW.

In some embodiments, the UE receives both configuration information #2 and indication #2. In some other embodiments, the UE receives configuration information #2, and configuration information #2 includes indication #2.

In some embodiments, the positioning measurement operation is performed by the UE based on one of:
(1) configuration information #1 and indication #1;
(2) configuration information #1 and indication #1 in response to a handover timer (e.g., T304 as defined in 3GPP standard documents) being running;
(3) configuration information #2 and/or indication #2; and
(4) prohibiting considering configuration information #1, indication #1, configuration information #2, and indication #2. That is, in some embodiments, the positioning measurement operation may be performed without considering configuration information #1, indication #1, configuration information #2, and indication #2. In these embodiments, the UE may continue to receive the DL-PRS during the handover procedure.

In some embodiments, in response to initiating the handover procedure, the UE may stop performing the positioning measurement operation. In an embodiment, the UE may stop receiving the DL-PRS upon initiating the handover procedure.

In some embodiments, the UE may restart to perform the positioning measurement operation in response to at least one of:
(1) transmitting an RRC reconfiguration complete message;
(2) stopping a handover timer (e.g., T304); or
(3) receiving an RRC reconfiguration message from the target network node. A specific example is described in the embodiments of FIG. 7 as follows.

It should be appreciated by persons skilled in the art that the sequence of the operations in exemplary procedure 500 may be changed and that some of the operations in exemplary procedure 500 may be eliminated or modified, without departing from the spirit and scope of the disclosure.

FIG. 6 illustrates a flowchart of an exemplary procedure 600 of wireless communications in accordance with some embodiments of the present disclosure. Details described in all other embodiments of the present disclosure are applicable for the embodiments shown in FIG. 6.

Exemplary procedure 600 refers to a scenario in which a UE is configured with a measurement gap and/or a PPW for reception of DL-PRS, and an RLF may happen when the UE performs a positioning measurements operation during the PPW and/or the measurement gap. Referring to FIG. 6, remote UE 601 may function as UE 201a as shown in FIG. 2, and BS 602 may function as BS 202a, BS 202b, or BS 202c as shown in FIG. 2, respectively. In particular, exemplary procedure 600 includes following operations.

In operation 611, UE 601 accesses the serving BS, e.g., BS 602. UE 601 may stay at an RRC connected state. In some embodiments, some entity in the 5GC (e.g., GMLC) may request some location service (e.g., positioning) for UE 601 (which may also be named as a target UE or a remote UE) to the serving AMF. In some embodiments, the serving AMF for UE 601 may determine the need for some location service and send the request for some location service (e.g., positioning) to UE 601.

In some embodiments, UE 601 is configured with DL-PRS, which could be associated with the serving cell or neighbor cell(s). For example, UE 601 may receive time-frequency resource configuration information associated with the DL-PRS from BS 602.

In some embodiments, UE 601 is configured with (pre-)configured PPW(s) where UE 601 is expected to measure the DL-PRS. Based upon an indication received in configuration information associated with the (pre-)configured PPW, UE 601 may identify whether the DL-PRS priority is higher than that of other DL signals or channels. For example, if UE 601 identifies that the DL-PRS priority is higher than that of other DL signals or channels, the UE may determine that UE 601 is expected to measure the DL-PRS and is not expected to receive and transmit other DL signals and channels. For instance, an ID of the PPW may be used to identify the PPW.

In some embodiments, UE 601 is (pre-)configured with measurement gap(s) for the reception of DL-PRS from neighbor cell(s). For instance, an ID of the measurement gap may be configured to UE 601.

In operation 612, UE 601 may receive an activation or deactivation indication (e.g., in a MAC CE) to activate or deactivate the (pre-)configured measurement gap and/or the (pre-)configured PPW.

In operation 613, after UE 601 receives the activation or deactivation indication, UE 601 may perform a positioning measurement operation (may also be named as “a measurement operation for positioning” or the like) using the activated measurement gap and/or the activated PPW.

In operation 614, UE 601 may declare a radio link failure (RLF) and may initiate an RRC reestablishment procedure.

In some embodiments, UE 601 may start a timer for RRC connection reestablishment (e.g., T311 as defined in 3GPP standard documents) for cell selection upon initiating the RRC reestablishment procedure. Once UE 601 selects a suitable cell, UE 601 may stop timer T311. Then, UE 601 may transmit an RRC reestablishment request and start a timer for RRC reestablishment request (e.g., T301 as defined in 3GPP standard documents). For instance, UE 601 may stop timer T301 upon reception of RRCReestablishment message.

In operation 615, there may be following different operations in different embodiments, e.g., Option X and Option Y.
(1) Option X: in operation 615, UE 601 keeps performing the positioning measurement operation during the RRC reestablishment procedure.
   a) In some embodiments, UE 601 will not release the configuration related with measurement gap and PPW when UE 601 initiates the RRC reestablishment procedure.
   b) In some other embodiments, UE 601 may release the configuration related with (pre-)configured measurement gap(s) and/or PPW(s). UE 601 may continue to receive DL-PRS during the RRC reestablishment procedure. In an embodiment, if the ra-ResponseWindow or the ra-ContentionResolutionTimer or the msgB-ResponseWindow is running, UE 601 may monitor a PDCCH transmission, e.g., in operation 615A (which is optional and marked as dotted line). Namely, when collision between reception of DL-PRS and reception associated with the RA operation, the reception associated with the RA operation will have a higher priority than that of the reception of the DL-PRS.
(2) Option Y: in operation 615, UE 601 may stop performing the positioning measurement operation. For instance, UE 601 may stop reception of the DL-PRS upon the initiation of the RRC reestablishment procedure or the declaration of the RLF.
   a) In some embodiments, after stopping the positioning measurement operation, UE 601 may receive RRCReestablishment message from the re-established cell, e.g., in operation 615A (optional), and may restart to perform the positioning measurement operation when receiving the RRCReestablishment message.

In operation 616, after successfully completing the RRC reestablishment procedure, UE 601 may report measurement result(s) of the positioning measurement operation to the network, e.g., BS 602 or the AMF or the LMF.

FIG. 7 illustrates a flowchart of an exemplary procedure 700 of wireless communications in accordance with some embodiments of the present disclosure. Details described in all other embodiments of the present disclosure are applicable for the embodiments shown in FIG. 7.

Exemplary procedure 700 refers to a scenario in which a UE is configured with a measurement gap and/or a PPW for reception of DL-PRS, and a handover may happen when the UE performs a positioning measurements operation during the PPW and/or the measurement gap. Referring to FIG. 7, remote UE 701 may function as UE 201a as shown in FIG. 2, and BS 702 may function as BS 202a, BS 202b, or BS 202c as shown in FIG. 2, respectively. In particular, exemplary procedure 700 includes following operations.

In operation 711, UE 701 accesses the serving BS, e.g., BS 702. UE 701 stays at an RRC connected state. In some embodiments, some entity in the 5GC (e.g., GMLC) may request some location service (e.g., positioning) for UE 701 (which may also be named as a target UE or a remote UE) to the serving AMF. In some embodiments, the serving AMF for UE 701 may determine the need for some location service and send the request for some location service (e.g., positioning) to UE 701.

In some embodiments, UE 701 is configured with DL-PRS, which could be associated with serving cell or neighbor cell(s). For example, UE 701 may receive configuration information associated with the DL-PRS from BS 702.

In some embodiments, UE 701 is configured with (pre-)configured PPW(s) where UE 701 is expected to measure the DL-PRS. Based upon an indication received in the configuration information associated with the (pre-)configured PPW, UE 701 may identify whether the DL-PRS priority is higher than that of other DL signals or channels and may accordingly determine, for example, that UE 701 is expected to measure the DL-PRS and is not expected to receive and transmit other DL signals and channels. For instance, an ID of the PPW may be used to identify the PPW.

In some embodiments, UE 701 is (pre-)configured with measurement gap(s) for the reception of DL-PRS from neighbor cell(s). For instance, an ID of the measurement gap may be configured to UE 701.

In operation 712, UE 701 may receive an activation or deactivation indication (e.g., in a MAC CE) to activate or deactivate the (pre-)configured measurement gap and/or the (pre-)configured PPW.

In operation 713, after UE 701 receives the activation or deactivation indication, UE 701 may perform a positioning measurement operation using the activated measurement gap and/or the activated PPW.

In operation 714, UE 701 may perform a handover procedure from BS 702 to a target BS, e.g., target BS 703, when UE 701 receives a handover command or the execution condition of CHO is met. In some embodiments, UE 701 may start a handover timer (e.g., T304) when UE 701 perform an RA operation to target BS 703 (e.g., in operation 714A). For instance, UE 701 may stop T304 when UE 701 successfully performs the RA operation.

In operation 715, there may be following different operations in different embodiments, e.g., Option A and Option B.
(1) Option A: in operation 715, UE 701 may keep performing the positioning measurement operation during the handover procedure.
   a) In some embodiments, UE 701 performs the positioning measurement operation based on the activated measurement gap and/or PPW configured by BS 802 (i.e., the source BS).
   b) In some further embodiments, UE 701 performs the positioning measurement operation based on the activated measurement gap and PPW configured by BS 802 when the handover timer (e.g., T304) is running. That is, if the handover timer is not running, UE 701 does not perform the positioning measurement operation based on the activated measurement gap and PPW configured by BS 802.
   c) In some other embodiments, UE 701 performs the positioning measurement operation based on the activated measurement gap and PPW configured by target BS 703. In such embodiments, UE 701 may receive, from target BS 703, configuration information associated with measurement gap(s) or PPW(s) and/or an indication for activating or deactivating a measurement gap within the measurement gap(s) or a PPW within the PPW(s).
   d) In some additional embodiments, UE 701 performs the positioning measurement operation without considering configuration information related with any measurement gap and/or PPW configured by BS 802 or target BS 703.
      (a) In an embodiment, UE 701 may continue to receive DL-PRS during the handover procedure.
      (b) In an embodiment, if the ra-ResponseWindow or the ra-ContentionResolutionTimer or the msgB-ResponseWindow is running, UE 701 may monitor a PDCCH transmission, e.g., in operation 715A (optional). Namely, when collision between reception of DL-PRS and reception associated the RA operation, the reception associated with the RA operation will have a higher priority than that of the reception of the DL-PRS.
(2) Option B: in operation 715, UE 701 may stop performing the positioning measurement operation during the handover procedure.
   a) In some embodiments, after stopping the positioning measurement operation, UE 601 may restart to perform the positioning measurement operation after transmitting an RRC reconfiguration complete message, stopping T304, or receiving an RRC reconfiguration message from BS 702, (e.g., in operation 715A).

In operation 716, after successfully completing the handover procedure, UE 701 reports measurement result(s) of the positioning measurement operation to the network, e.g., target BS 703 or the AMF or the LMF.

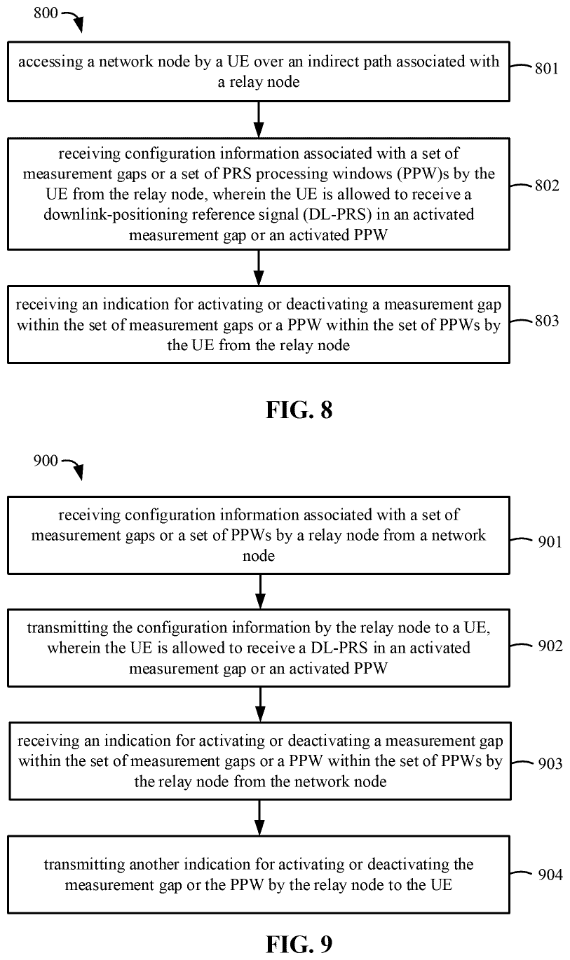

FIG. 8 illustrates a flowchart of an exemplary procedure 800 of a positioning measurement operation in accordance with some embodiments of the present disclosure. The exemplary procedure 800 may be performed by a UE, e.g., UE 101 as shown in FIG. 1. Although described with respect to a UE, it should be understood that other devices may be configured to perform a method similar to that of FIG. 8. Details described in all other embodiments of the present disclosure are applicable for the embodiments shown in FIG. 8.

In the exemplary procedure 800 as shown in FIG. 8, in operation 801, a UE may access a network node (e.g., BS 102 as shown in FIG. 1) over an indirect path associated with a relay node (e.g., relay UE 103 as shown in FIG. 1).

In operation 802, the UE may receive configuration information associated with a set of measurement gaps or a set of PPWs from the relay node. The UE is allowed to receive a DL-PRS in an activated measurement gap or an activated PPW. In some embodiments, the UE may receive configuration information associated with the DL-PRS, e.g., time-frequency resource configuration information for the DL-PRS.

In operation 803, the UE may receive “an indication (denoted as indication #a) for activating or deactivating a measurement gap within the set of measurement gaps or a PPW within the set of PPWs” from the relay node. In some embodiments, the indication is included in a PC5 SRAP control PDU and/or a PC5 MAC CE. In some embodiments, indication #a includes at least one of:
(1) An ID of the measurement gap or the PPW.
(2) An indicator for indicating activation of the measurement gap or the PPW (e.g., “A” field or “A/D” field in indication #a). In an embodiment, if the indication includes the indicator for indicating the activation of the PPW, the UE may prohibit receiving a transmission on a PC5 path (e.g., a PSCCH transmission; a PSSCH transmission; and/or a SL-SCH transmission) within the PPW.
(3) An indicator for indicating deactivation of the measurement gap or the PPW (e.g., “D” field or “A/D” field in indication #a).
(4) Information regarding frequency resource(s) for the UE receiving indication #a. That is, the UE may receive indication #a at the frequency resource(s). For example, the information regarding the frequency resource(s) may be implicitly included in indication #a.

In some embodiments, the UE may transmit a request for activation or deactivation of the measurement gap to the relay node. In an embodiment, the request is included a PC5 SRAP control PDU and/or a PC5 MAC CE. For instance, the request includes at least one of:
(1) an ID of the measurement gap;
(2) an indicator for indicating activation of the measurement gap; or
(3) an indicator for indicating deactivation of the measurement gap. A specific example is described in the embodiments of FIG. 11 as follows.

FIG. 9 illustrates a flowchart of an exemplary procedure 900 of a positioning measurement operation in accordance with some embodiments of the present disclosure. The exemplary procedure 900 may be performed by a relay node, e.g., relay UE 103 as shown in FIG. 1. Although described with respect to a relay node, it should be understood that other devices may be configured to perform a method similar to that of FIG. 9. Details described in all other embodiments of the present disclosure are applicable for the embodiments shown in FIG. 9.

In the exemplary procedure 900 as shown in FIG. 9, in operation 901, a relay node may receive configuration information associated with a set of measurement gaps or a set of PPWs from a network node (e.g., BS 102 as shown in FIG. 1).

In operation 902, the relay node may transmit the configuration information to a UE (e.g., UE 101 as shown in FIG. 1). The UE is allowed to receive a DL-PRS in an activated measurement gap or an activated PPW.

In operation 903, the relay node may receive “an indication (denoted as indication #A) for activating or deactivating a measurement gap within the set of measurement gaps or a PPW within the set of PPWs” from the network node. For instance, indication #A is included in a Uu SRAP control PDU and/or a Uu MAC CE. In some embodiments, indication #A includes at least one of:
(1) an ID of the measurement gap or the PPW;
(2) an indicator for indicating activation of the measurement gap or the PPW;
(3) an indicator for indicating deactivation of the measurement gap or the PPW;
(4) information regarding one or more frequency resources for the UE receiving indication #B (e.g., the information is explicitly included in indication #A); or
(5) an ID of the UE.

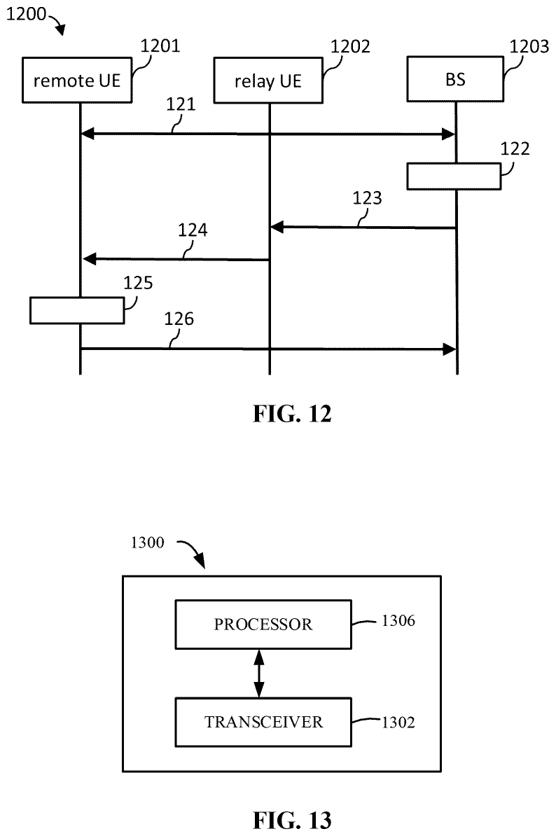

In operation 904, the relay node may transmit another indication (denoted as indication #B) for activating or deactivating the measurement gap or the PPW to the UE. For instance, indication #B is included in a PC5 SRAP control PDU and/or a PC5 MAC CE. In some embodiments, indication #B includes at least one of:
(1) an ID of the measurement gap or the PPW;
(2) an indicator for indicating activation of the measurement gap or the PPW (e.g., “A” field or “A/D” field in indication #B);
(3) an indicator for indicating deactivation of the measurement gap or the PPW (e.g., “D” field or “A/D” field in indication #B); or
(4) information regarding frequency resource(s) for the UE receiving indication #B. (e.g., the information is implicitly included in indication #B). That is, the UE may receive indication #B at the frequency resource(s). A specific example is described in the embodiments of FIG. 12 as follows.

In some embodiments, the relay node may receive a request for activation or deactivation of the measurement gap from the UE. For instance, the request is included in a PC5 SRAP control PDU and/or a PC5 MAC CE. In an embodiment, the request includes at least one of:
(1) an ID of the measurement gap;
(2) an indicator for indicating activation of the measurement gap; or
(3) an indicator for indicating deactivation of the measurement gap.

In some embodiments, the relay node may transmit a further request for the activation or deactivation of the measurement gap to the network node. For instance, the further request is included in a Uu SRAP control PDU and/or a Uu MAC CE. In an embodiment, the further request includes at least one of:
(1) an ID of the measurement gap;
(2) an indicator for indicating activation of the measurement gap; or
(3) an indicator for indicating deactivation of the measurement gap; or
(4) an ID of the UE. A specific example is described in the embodiments of FIG. 11 as follows.

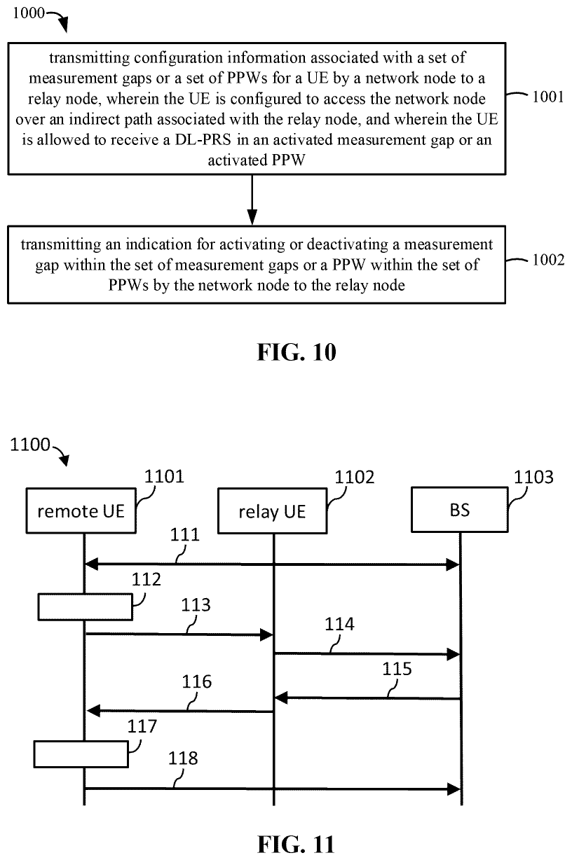

FIG. 10 illustrates a flowchart of an exemplary procedure 1000 of a positioning measurement operation in accordance with some embodiments of the present disclosure. The exemplary procedure 1000 may be performed by a network node, e.g., BS 102 as shown in FIG. 1. Although described with respect to a network node, it should be understood that other devices may be configured to perform a method similar to that of FIG. 10. Details described in all other embodiments of the present disclosure are applicable for the embodiments shown in FIG. 10.

In the exemplary procedure 1000 as shown in FIG. 10, in operation 1001, a network node may transmit, to a relay node (e.g., relay UE 103 as shown in FIG. 1), configuration information associated with a set of measurement gaps or a set of PPWs for a UE (e.g., UE 101 as shown in FIG. 1). The UE may be configured to access the network node over an indirect path associated with the relay node. The UE may be allowed to receive a DL-PRS in an activated measurement gap or an activated PPW.

In operation 1002, the network node may transmit “an indication for activating or deactivating a measurement gap within the set of measurement gaps or a PPW within the set of PPWs” to the relay node. For instance, the indication is included in a Uu SRAP control PDU and/or a Uu MAC CE. In some embodiments, the indication includes at least one of:
(1) an ID of the measurement gap or the PPW;
(2) an indicator for indicating activation of the measurement gap or the PPW;
(3) an indicator for indicating deactivation of the measurement gap or the PPW;
(4) information regarding frequency resource(s) for the UE receiving an indication for activation or deactivation of the measurement gap or the PPW (e.g., the information is explicitly included in the indication); or
(5) an ID of the UE. A specific example is described in the embodiments of FIG. 12 as follows.

In some embodiments, the network node may receive a request for activation or deactivation of the measurement gap from the relay node. For instance, the request is included in at least one of: a Uu SRAP control PDU; or a Uu MAC CE. In some embodiments, the request includes at least one of:
(1) an ID of the measurement gap;
(2) an indicator for indicating activation of the measurement gap; or
(3) an indicator for indicating deactivation of the measurement gap; or
(4) an ID of the UE. A specific example is described in the embodiments of FIG. 11 as follows.

It should be appreciated by persons skilled in the art that the sequence of the operations in any of exemplary procedures 800-1000 in FIGS. 8-10 may be changed and that some of the operations in any of exemplary procedures 800-1000 may be eliminated or modified, without departing from the spirit and scope of the disclosure.

FIG. 11 illustrates a flowchart of an exemplary procedure 1100 of wireless communications in accordance with some embodiments of the present disclosure. Details described in all other embodiments of the present disclosure are applicable for the embodiments shown in FIG. 11.

Exemplary procedure 1100 refers to a scenario in which a UE is a remote UE accessing a BS via a relay UE, and a positioning measurement gap activation or deactivation request MAC CE cannot be transmitted between the remote UE and the BS directly. Referring to FIG. 11, remote UE 1101, relay UE 1102, and BS 1103 may function as UE 101, relay UE 103, and BS 102 shown in FIG. 1, respectively. In particular, exemplary procedure 1100 includes following operations.

In operation 111, remote UE 101 accesses BS 1103 via relay UE 1102, e.g., which is a L2 U2N relay UE. In other words, remote UE 1101 accesses a serving cell of BS 1103 via an indirect path. Remote UE 1101 may stay at an RRC connected state.

In some embodiments, some entity in the 5GC (e.g., GMLC) requests some location service (e.g., positioning) for remote UE 1101 (which may also be named as a target UE) to the serving AMF. In some embodiments, the serving AMF for remote UE 1101 determines the need for some location service and sends the request for some location service (e.g., positioning) to remote UE 1101.

In some embodiments, remote UE 1101 is configured with DL-PRS, which could be associated with the serving cell or neighbor cell(s). For example, remote UE 1101 may receive time-frequency resource configuration information associated with the DL-PRS from BS 1103.

In some embodiments, remote UE 1101 is (pre-)configured with measurement gap(s) for the reception of DL-PRS from neighbor cells. For instance, an ID of the measurement gap may be configured to remote UE 1101. The measurement gap(s) may also be named as “positioning measurement gap(s)” or “measurement gap(s) for positioning” or the like.

In operation 112, remote UE 1101 wants to activate or deactivate at least one of the (pre-)configured measurement gaps.

In some embodiments, in operations 113 and 114, remote UE 1101 will transmit “an RRC message including an ID of the measurement gap” and/or “an indicator indicating activation or deactivation of the measurement gap” to BS 1103 via relay UE 1102.

In some other embodiments, in operations 113 and 114, following options may be adopted in different embodiments for an uplink from remote UE 1101 to BS 1103 via relay UE 1102, i.e., Option (1) and Option (2).
(1) Option (1):
   a) In operation 113, remote UE 1101 may transmit a request for activation or deactivation of a measurement gap to relay UE 1102 via a PC5 SRAP control PDU. For instance, the request may include: an ID of the measurement gap, and/or an indicator indicating the activation or deactivation of the measurement gap.
   b) After relay UE 1102 receives the request from remote UE 1101, relay UE 1102 needs to indicate to BS 1103. For example, in operation 114, relay UE 1102 may transmit a further request for activation or deactivation the measurement gap to BS 1103 via a Uu SRAP control PDU. The further request may include: an ID of the measurement gap, an indicator indicating the activation or deactivation of the measurement gap, and/or an ID of remote UE 1101.
(2) Option (2):
   a) In operation 113, remote UE 1101 may transmit a request for activation or deactivation of a measurement gap to relay UE 1102 via a PC5 MAC CE. For instance, the request may include: an ID of the measurement gap, and/or an indicator indicating the activation or deactivation of the measurement gap.
   b) After relay UE 1102 receives the request from remote UE 1101, relay UE 1102 needs to indicate to BS 1103. For example, in operation 114, relay UE 1102 may transmit a further request for activation or deactivation the measurement gap to BS 1103 via a Uu MAC CE. The further request may include: an ID of the measurement gap, an indicator indicating the activation or deactivation of the measurement gap, and/or an ID of remote UE 1101.

After operation 114, BS 1103 may activate or deactivate the positioning measurement gap. There may be following different embodiments.

In some embodiments, in operations 115 and 116, BS 1103 may transmit an RRC message including the ID of the measurement gap and/or an indicator indicating the activation or deactivation of the measurement gap to remote UE 1101 via relay UE 1102.

In some other embodiments, in operations 115 and 116, following options may be adopted in different embodiments for a downlink from BS 1103 to remote UE via relay UE 1102, i.e., Option (a) and Option (b).
(1) Option (a):
   a) In operation 115, BS 1103 transmits an activation or deactivation indication (which may be named as “an activation or deactivation command” or the like) to relay UE 1102 via a Uu SRAP control PDU. For instance, the activation or deactivation indication may include: an ID of a measurement gap, an indicator indicating the activation or deactivation of the measurement gap, and/or an ID of remote UE 1101.
   b) After relay UE 1102 receives the activation or deactivation indication from BS 1103, relay UE 1102 needs to indicate to remote UE 1101. For example, in operation 116, relay UE 1102 may transmit a further activation or deactivation indication to remote UE 1101 via a PC5 SRAP control PDU. The further activation or deactivation indication may include: an ID of the measurement gap, and/or an indicator indicating the activation or deactivation of the measurement gap.
(2) Option (b):
   a) In operation 115, BS 1103 transmits an activation or deactivation indication (i.e., “an activation or deactivation command”) to relay UE 1102 via a Uu MAC CE. For instance, the activation or deactivation indication may include: an ID of a measurement gap, an indicator indicating the activation or deactivation of the measurement gap, and/or an ID of remote UE 1101.
   b) After relay UE 1102 receives the activation or deactivation indication from BS 1103, relay UE 1102 needs to indicate to remote UE 1101. For example, in operation 116, relay UE 1102 may transmit a further activation or deactivation indication to remote UE 1101 via a PC5 MAC CE. The further activation or deactivation indication may include: an ID of the measurement gap, and/or an indicator indicating the activation or deactivation of the measurement gap.

In operation 117, remote UE 1101 performs a positioning measurement operation using the activated measurement gap.

In operation 118, remote UE 1101 reports measurement result(s) of the positioning measurement operation to the network, e.g., BS 1103 or the AMF or the LMF.

FIG. 12 illustrates a flow chart of an exemplary procedure 1200 of wireless communications in accordance with some embodiments of the present disclosure. Details described in all other embodiments of the present disclosure are applicable for the embodiments shown in FIG. 12.

Exemplary procedure 1200 refers to a scenario in which a UE can perform DL-PRS measurement outside measurement gap(s) and inside the active DL BWP with PRS having the same numerology as the active DL BWP, and a BS can use RRC signalling to (pre-)configure a PPW and DL MAC CE signaling for activation of the PPW, respectively, and if the target UE is a remote UE accessing a BS via a relay UE, the BWP could be PC5 BWP. Referring to FIG. 12, remote UE 1201, relay UE 1202, and BS 1203 may function as UE 101, relay UE 103, and BS 102 shown in FIG. 1, respectively. In particular, exemplary procedure 1200 includes following operations.

In operation 121, remote UE 1201 accesses BS 1203 via relay UE 1202, e.g., which is a L2 U2N relay UE. Remote UE 1201 stays at an RRC connected state.

In some embodiments, some entity in the 5GC (e.g., GMLC) requests some location service (e.g., positioning) for remote UE 1201 (which may also be named as a target UE) to the serving AMF. In some embodiments, the serving AMF for remote UE 1201 determines the need for some location service and sends the request for some location service (e.g., positioning) to remote UE 1201.

In some embodiments, remote UE 1201 is configured with DL-PRS, which could be associated with the serving cell or neighbor cell(s). For example, remote UE 1201 may receive time-frequency resource configuration information associated with the DL-PRS from BS 1203.

In some embodiments, remote UE 1201 is (pre-)configured with PPW(s) where remote UE 1201 is expected to measure the DL-PRS. Based upon an indication received in the configuration information associated with the PPW(s), remote UE 1201 may identify whether the DL-PRS priority is higher than that of other PC5 signals or channels and accordingly determine, for example, that remote UE 1201 is expected to measure the DL-PRS and is not expected to receive and transmit other PC5 signals and channels. For instance, an ID of the PPW may be used to identify the PPW.

In some embodiments, remote UE 1201 is (pre-)configured with measurement gap(s) for the reception of DL-PRS from neighbor cell(s). For instance, an ID of the measurement gap may be configured to remote UE 1201.

After operation 122, BS 1203 wants to activate a (pre-)configured PPW.

In some embodiments, in operations 123 and 124, BS 1203 may transmit an RRC message, which includes an ID of the PPW and/or an indicator indicating the activation or deactivation of the PPW, to remote UE 1201 via relay UE 1202.

In some other embodiments, in operations 123 and 124, following options may be adopted in different embodiments for a downlink from BS 1203 to remote UE via relay UE 1202, i.e., Option 1 and Option 2.
(1) Option 1:
   (a) In operation 123, BS 1203 may transmit an indication for activation or deactivation of a PPW to relay UE 1202 via a Uu SRAP control PDU. For instance, the indication may include an ID of the PPW, an indicator indicating activation or deactivation of the PPW, information regarding frequency resource(s) for UE 1201 receiving an activation or deactivation indication of the PPW (i.e., the further indication in operation 124), and/or an ID of remote UE 1201. For instance, the information regarding the frequency resource(s) is explicitly included in the indication in operation 123.
   (b) After relay UE 1202 receives the activation or deactivation indication from BS 1203, relay UE 1202 needs to indicate to remote UE 1201. For example, in operation 124, relay UE 1102 may transmit a further indication for activation or deactivation of the PPW to remote UE 1201 via a PC5 SRAP control PDU. The further indication may include: an ID of the PPW, an indicator indicating activation or deactivation of the PPW; and/or information regarding frequency resource(s) for UE 1201 receiving the further indication. For instance, the information regarding the frequency resource(s) is implicitly included in the further indication in operation 124.
(2) Option 2:
   (a) In operation 123, BS 1203 may transmit an indication for activation or deactivation of a PPW to relay UE 1202 via a Uu MAC CE. For instance, the indication may include an ID of the PPW, an indicator indicating activation or deactivation of the PPW, information regarding frequency resource(s) for UE 1201 receiving an activation or deactivation indication of the PPW (i.e., the further indication in operation 124) (e.g., the information is explicitly included in the indication in operation 123), and/or an ID of remote UE 1201.
   (b) After relay UE 1202 receives the activation or deactivation indication from BS 1203, relay UE 1202 needs to indicate to remote UE 1201. For example, in operation 124, relay UE 1102 may transmit a further indication for activation or deactivation of the PPW to remote UE 1201 via a PC5 MAC CE. The further indication may include: an ID of the PPW, an indicator indicating the activation or deactivation of the PPW, and/or information regarding frequency resource(s) for UE 1201 receiving the further indication (e.g., the information is implicitly included in the further indication in operation 124).

In operation 125, after remote UE 1201 receives the activation or deactivation indication, remote UE 1201 performs a positioning measurement operation using the activated PPW. In some embodiments, when a PPW is activated and PRS has a higher priority than that of PC5 channels and signals, for the affected symbols within the PC5 PPW, remote UE 1201 do not receive PSCCH, PSSCH, or SL-SCH transmission(s).

In operation 126, remote UE 1201 reports measurement result(s) of the positioning measurement operation to the network, e.g., BS 1203 or the AMF or the LMF.

It should be appreciated by persons skilled in the art that the sequence of the operations in exemplary procedure 1100 or 1200 in FIG. 11 or FIG. 12 may be changed and some of the operations in exemplary procedure 1100 or 1200 may be eliminated or modified, without departing from the spirit and scope of the disclosure.

FIG. 13 illustrates a block diagram of an exemplary apparatus 1300 in accordance with some embodiments of the present disclosure. As shown in FIG. 13, the apparatus 1300 may include at least one processor 1306 and at least one transceiver 1302 coupled to the processor 1306. The apparatus 1300 may be a UE (a remote UE or a relay UE) or a network node (e.g., a BS).

Although in this figure, elements such as the at least one transceiver 1302 and processor 1306 are described in the singular, the plural is contemplated unless a limitation to the singular is explicitly stated. In some embodiments of the present application, the transceiver 1302 may be divided into two devices, such as a receiving circuitry and a transmitting circuitry. In some embodiments of the present application, the apparatus 1300 may further include an input device, a memory, and/or other components.

In some embodiments of the present application, the apparatus 1300 may be a remote UE, a relay UE, or a network node (e.g., a BS, for example, a gNB). The transceiver 1302 and the processor 1306 may interact with each other so as to perform the operations with respect to the UEs or the network node described above, for example, in FIGS. 1-12.

In some embodiments of the present application, the apparatus 1300 may further include at least one non-transitory computer-readable medium. For example, in some embodiments of the present disclosure, the non-transitory computer-readable medium may have stored thereon computer-executable instructions to cause the processor 1306 to implement the method with respect to the UEs as described above. For example, the computer-executable instructions, when executed, cause the processor 1306 interacting with transceiver 1302 to perform the operations with respect to the remote UEs or relay UEs described in FIGS. 1-12.

For example, in some embodiments of the present disclosure, the non-transitory computer-readable medium may have stored thereon computer-executable instructions to cause the processor 1306 to implement the method with respect to the network nodes as described above. For example, the computer-executable instructions, when executed, cause the processor 1306 interacting with transceiver 1302 to perform the operations with respect to the network nodes described in FIGS. 1-12.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1-15. (canceled)

16. A user equipment (UE) for wireless communication, comprising:
at least one memory; and
at least one processor coupled with the at least one memory and configured to cause the UE to:
receive configuration information associated with a downlink-positioning reference signal (DL-PRS) from a network node;
start to perform a positioning measurement operation based on the configuration information;
after starting to perform the positioning measurement operation, initiate a radio resource control (RRC) reestablishment procedure or a handover procedure from the network node to a target network node; and
determine whether to continue performing the positioning measurement operation in response to initiating the RRC reestablishment procedure or the handover procedure.

17. The UE of claim 16, wherein the at least one processor is further configured to cause the UE to perform the positioning measurement operation in response to receiving the DL-PRS.

18. The UE of claim 16, wherein the at least one processor is further configured to cause the UE to receive first configuration information associated with a first set of measurement gaps or a first set of PRS processing windows (PPWs) from the network node.

19. The UE of claim 16, wherein, in response to initiating the RRC reestablishment procedure, the at least one processor is further configured to cause the UE to continue to perform the positioning measurement operation during the RRC reestablishment procedure.

20. The UE of claim 19, wherein the at least one processor is further configured to cause the UE to perform one of:
maintaining the first configuration information;
releasing the first configuration information, and
continuing to receive the DL-PRS during the RRC reestablishment procedure.

21. The UE of claim 20, wherein, in response to releasing the first configuration information, the at least one processor is further configured to cause the UE to monitor a physical downlink control channel (PDCCH) transmission in response to at least one of:
a timer for a random access (RA) response window is running;
a RA contention resolution timer is running; or
a timer for an MsgB response window is running.

22. The UE of claim 16, wherein, in response to initiating the RRC reestablishment procedure, the at least one processor is further configured to cause the UE to stop performing the positioning measurement operation.

23. The UE of claim 22, wherein the at least one processor is further configured to cause the UE to stop receiving the DL-PRS upon initiating the RRC reestablishment procedure.

24. The UE of claim 22, wherein the at least one processor is further configured to cause the UE to:
receive an RRC reestablishment message from a reestablished cell; and
restart performing the positioning measurement operation in response to receiving the RRC reestablishment message.

25. The UE of claim 16, wherein, in response to initiating the handover procedure, the at least one processor is further configured to cause the UE to continue to perform the positioning measurement operation during the handover procedure.

26. The UE of claim 25, wherein the at least one processor is further configured to cause the UE to monitor a physical downlink control channel (PDCCH) transmission during the handover procedure in response to at least one of:
a timer for a random access (RA) response window is running;
a RA contention resolution timer is running; or
a timer for an MsgB response window is running.

27. The UE of claim 16, wherein the at least one processor is further configured to cause the UE to receive a first indication for activating or deactivating a first measurement gap within a first set of measurement gaps or a first PRS processing window (PPW) within a first set of PPWs from the network node.

28. The UE of claim 27, wherein the at least one processor is further configured to cause the UE to receive, from the target network node, at least one of:
second configuration information associated with a second set of measurement gaps or a second set of PPWs; or
a second indication for activating or deactivating a second measurement gap within the second set of measurement gaps or a second PPW within the second set of PPWs.

29. The UE of claim 28, wherein the second configuration information includes the second indication.

30. A method performed by a user equipment (UE), the method comprising:
receiving configuration information associated with a downlink-positioning reference signal (DL-PRS) from a network node;
starting to perform a positioning measurement operation based on the configuration information;
after starting to perform the positioning measurement operation, initiating a radio resource control (RRC) reestablishment procedure or a handover procedure from the network node to a target network node; and
determining whether to continue performing the positioning measurement operation in response to initiating the RRC reestablishment procedure or the handover procedure.

31. The method of claim 30, further comprising:
performing the positioning measurement operation in response to receiving the DL-PRS.

32. A network node for wireless communication, comprising:
at least one memory; and
at least one processor coupled with the at least one memory and configured to cause the network node to:
transmit configuration information associated with a set of measurement gaps or a set of positioning reference signal processing windows (PPWs) for a user equipment (UE) to a relay node, wherein the UE is configured to access the network node over an indirect path associated with the relay node, and wherein the UE is allowed to receive a downlink-positioning reference signal (DL-PRS) in an activated measurement gap or an activated PPW; and
transmit an indication for activating or deactivating a measurement gap within the set of measurement gaps or a PPW within the set of PPWs to the relay node.

33. The network node of claim 32, wherein the indication includes at least one of:
an identifier (ID) of the measurement gap or the PPW;
an indicator for indicating activation of the measurement gap or the PPW;
an indicator for indicating deactivation of the measurement gap or the PPW;
information regarding one or more frequency resources for the UE receiving an indication for activation or deactivation of the measurement gap or the PPW; or
an ID of the UE.

34. The network node of claim 32, wherein the indication is included in at least one of:
a Uu sidelink relay adaptation protocol (SRAP) control protocol data unit (PDU); or
a Uu medium access control (MAC) control element (CE).

35. A relay node, comprising:
at least one memory; and
at least one processor coupled with the at least one memory and configured to cause the relay node to:
receive configuration information associated with a set of measurement gaps or a set of positioning reference signal processing windows (PPWs) from a network node;
transmit the configuration information via the transceiver to a user equipment (UE), wherein the UE is allowed to receive a downlink-positioning reference signal (DL-PRS) in an activated measurement gap or an activated PPW;
receive a first indication for activating or deactivating a measurement gap within the set of measurement gaps or a PPW within the set of PPWs via the transceiver from the network node; and
transmit a second indication for activating or deactivating the measurement gap or the PPW to the UE.
